(19) United States
(12) Patent Application Publication
(10) Pub. No.: US 2007/0153125 A1
(43) Pub. Date: Jul. 5, 2007

(54) Method, system, and program product for measuring audio video synchronization

(75) Inventors: J. Carl Cooper, Incline Village, NV (US); Mirko Dusan Vojnovic, Santa Clara, CA (US); Jibanananda Roy, Kolkata (IN); Saurabh Jain, New Dehli (IN); Christopher Smith, Simsbury, CT (US)

Correspondence Address: STEVENS LAW GROUP, P.O. BOX 1667, SAN JOSE, CA, 95109, US

(73) Assignee: Pixel Instruments, Corp., Los Gatos, CA (US)

(21) Appl. No.: 11/598,871

(22) Filed: Nov. 13, 2006

Related U.S. Application Data
(63) Continuation-in-part of application No. 10/846,133, filed on May 14, 2004.
(60) Provisional application No. 60/471,176, filed on May 16, 2003.

(51) Int. Cl. H04N 17/02; H04N 9/475

(52) U.S. Cl. 348/515; 348/194

(57) ABSTRACT

Method, system, and program product for measuring audio video synchronization. This is done by first acquiring audio video information into an audio video synchronization system. The step of data acquisition is followed by analyzing the audio information, and analyzing the video information. In this phase audio and video information is analyzed, decision boundaries for Audio and Video MuEv-s are determined, and related Audio and Video MuEv-s are correlated. In Analysis Phase Audio and Video MuEv-s are calculated from the audio and video information, and the audio and video information is classified into vowel sounds including AA, EE, OO, silence, and unclassified phonemes This information is used to determine and associate a dominant audio class in a video frame. Matching locations are determined, and the offset of video and audio is determined.

### BACKGROUND OF INVENTION

1. Field of the Invention

The invention relates to the creation, manipulation, transmission, storage, etc. and especially synchronization of multi-media entertainment, educational and other programming having at least video and associated information.

2. Background Art

The creation, manipulation, transmission, storage, etc. of multi-media entertainment, educational and other programming having at least video and associated information requires synchronization. Typical examples of such programming are television and movie programs. Often these programs include a visual or video portion, an audible or audio portion, and may also include one or more various data type portions. Typical data type portions include closed captioning, narrative descriptions for the blind, additional program information data such as web sites and further information directives and various metadata included in compressed (such as for example MPEG and JPEG) systems.

Often the video and associated signal programs are produced, operated on, stored or conveyed in a manner such that the synchronization of various ones of the aforementioned audio, video and/or data is affected. For example the synchronization of audio and video, commonly known as lip sync, may be askew when the program is produced. If the program is produced with correct lip sync, that timing may be upset by subsequent operations, for example such as processing, storing or transmission of the program.

One aspect of multi-media programming is maintaining audio and video synchronization in audio-visual presentations, such as television programs, for example to prevent annoyances to the viewers, to facilitate further operations with the program or to facilitate analysis of the program. Various approaches to this challenge are described in commonly assigned, issued patents. U.S. Pat. No. 4,313,135, U.S. Pat. No. 4,665,431; U.S. Pat. No. 4,703,355; U.S. Pat. No. Re. 33,535; U.S. Pat. No. 5,202,761; U.S. Pat. No. 5,530,483; U.S. Pat. No. 5,550,594; U.S. Pat. No. 5,572,261; U.S. Pat. No. 5,675,388; U.S. Pat. No. 5,751,368; U.S. Pat. No. 5,920,842; U.S. Pat. No. 5,946,049; U.S. Pat. No. 6,098,046; U.S. Pat. No. 6,141,057; U.S. Pat. No. 6,330,033; U.S. Pat. No. 6,351,281; U.S. Pat. No. 6,392,707; U.S. Pat. No. 6,421,636 and U.S. Pat. No. 6,469,741. Generally these patents deal with detecting, maintaining and correcting lip sync and other types of video and related signal synchronization.

U.S. Pat. No. 5,572,261 describes the use of actual mouth images in the video signal to predict what syllables are being spoken and compare that information to sounds in the associated audio signal to measure the relative synchronization. Unfortunately when there are no images of the mouth, there is no ability to determine which syllables are being spoken.

As another example, in systems where the ability to measure the relation between audio and video portions of programs, an audio signal may correspond to one or more of a plurality of video signals, and it is desired to determine which. For example in a television studio where each of three speakers wears a microphone and each actor has a corresponding camera which takes images of the speaker, it is desirable to correlate the audio programming to the video signals from the cameras. One use of such correlation is to automatically select (for transmission or recording) the camera which televises the actor which is currently speaking. As another example when a particular camera is selected it is useful to select the audio corresponding to that video signal. In yet another example, it is useful to inspect an output video signal, and determine which of a group of video signals it corresponds to thereby facilitating automatic selection or timing of the corresponding audio. Commonly assigned patents describing these types of systems are described in U.S. Pat. Nos. 5,530,483 and 5,751,368.

The above patents are incorporated in their entirety herein by reference in respect to the prior art teachings they contain.

Generally, with the exception of U.S. Pat. Nos. 5,572,261, 5,530,483 and 5,751,368, the above patents describe operations without any inspection or response to the video signal images. Consequently the applicability of the descriptions of the patents is limited to particular systems where various video timing information, etc. is utilized. U.S. Pat. Nos. 5,530,483 and 5,751,368 deal with measuring video delays and identifying video signal by inspection of the images carried in the video signal, but do not make any comparison or other inspection of video and audio signals. U.S. Pat. No. 5,572,261 teaches the use of actual mouth images in the video signal and sounds in the associated audio signal to measure the relative synchronization. U.S. Pat. No. 5,572.261 describes a mode of operation of detecting the occurrence of mouth sounds in both the lips and audio. For example, when the lips take on a position used to make a sound like an E and an E is present in the audio, the time relation between the occurrences of these two events is used as a measure of the relative delay there between. The description in U.S. Pat. No. 5,572,261 describes the use of a common attribute for example such as particular sounds made by the lips, which can be detected in both audio and video signals. The detection and correlation of visual positioning of the lips corresponding to certain sounds and the audible presence of the corresponding sound is computationally intensive leading to high cost and complexity.

In a paper, J. Hershey, and J. R. Movellan (“Audio-Vision: Locating sounds via audio-visual synchrony” Advances in Neural Information Processing Systems 12, edited by S. A. Solla, T. K. Leen, K-R Muller. MIT Press, Cambridge, Mass. (MIT Press, Cambridge, Mass., (c) 2000)) it was recognized that sounds could be used to identify corresponding individual pixels in the video image The correlation between the audio signal and individual ones of the pixels in the image were used to create movies that show the regions of the video that have high correlation with the audio and from the correlation data they estimate the centroid of image activity and use this to find the talking face. Hershey et al. described the ability to identify which of two speakers in a television image was speaking by correlating the sound and different parts of the face to detect synchronization. Hershey et al. noted, in particular, that “[i]t is interesting that the synchrony is shared by some parts, such as the eyes, that do not directly contribute to the sound, but contribute to the communication nonetheless.” There was no suggestion by Hershey and Movellan that their algorithms could measure synchronization or perform any of the other features of the present invention.

In another paper, M. Slaney and M. Covell (“FaceSync: A linear operator for measuring synchronization of video facial images and audio tracks” available at www.slaney.org). described that Eigen Points could be used to identify lips of a speaker, whereas an algorithm by Yehia, Ruben, Batikiotis-Bateson could be used to operate on a corresponding audio signal to provide positions of the fiduciary points on the face The similar lip fiduciary points from the image and fiduciary points from the Yehia algorithm were then used for a comparison to determine lip sync. Slaney and Covell went on to describe optimizing this comparison in “an optimal linear detector, equivalent to a Wiener filter, which combines the information from all the pixels to measure audio-video synchronization.” Of particular note, “information from all of the pixels was used” in the FaceSync algorithm, thus decreasing the efficiency by taking information from clearly unrelated pixels. Further, the algorithm required the use of training to specific known face images, and was further described as “dependent on both training and testing data sizes.” Additionally, while Slaney and Covell provided mathematical explanation of their algorithm, they did not reveal any practical manner to implement or operate the algorithm to accomplish the lip sync measurement. Importantly the Slaney and Covell approach relied on fiduciary points on the face, such as corners of the mouth and points on the lips.

### SUMMARY OF INVENTION

The shortcoming of the prior art are eliminated by the method, system, and program product described herein.

The present invention provides for directly comparing images conveyed in the video portion of a signal to characteristics in an associated signal, such as an audio signal. More particularly, there is disclosed a method, system, and program product for measuring audio video synchronization.

We introduce the terms Audio and Video MuEv (ref. US Patent Application 20040227856). MuEv is the contraction of Mutual Event, to mean an event occurring in an image, signal or data which is unique enough that it may be accompanied by another MuEv in an associated signal. Such two MuEv-s are, for example, Audio and Video MuEv-s, where certain video quality (or sequence) corresponds to a unique and matching audio event.

The present invention provides for directly comparing images conveyed in the video portion of a signal to characteristics in an associated signal, such as an audio signal. More particularly, there is disclosed a method, system, and program product for measuring audio video synchronization.

This is done by first acquiring Audio and Video MuEv-s from input audio-video signals, and using them to calibrate an audio video synchronization system. The MuEv acquisition and calibration phase is followed by analyzing the audio information, and analyzing the video information. From this a Audio MuEv-s and Video MuEv-s are calculated from the audio and video information, and the audio and video information is classified into vowel sounds including, but not limited to, AA, EE, OO, silence, and other unclassified phonemes. This information is used to determine and associate a dominant audio class with corresponding video frame. Matching locations are determined, and the offset of video and audio is determined.

The present invention provides for directly comparing images conveyed in the video portion of a signal to characteristics in an associated signal, such as an audio signal. More particularly, there is disclosed a method, system, and program product for measuring audio video synchronization. This is done by first acquiring the data into an audio video synchronization system by receiving audio video information. Data acquisition is followed by analyzing the audio information, and analyzing the video information. From this a glottal pulse is calculated from the audio and video information, and the audio and video information is classified into vowel sounds including AA, EE, OO, silence, and unclassified phonemes This information is used to determine and associate a dominant audio class in a video frame. Matching locations are determined, and the offset of video and audio is determined.

One aspect of the invention is a method for measuring audio video synchronization. The method comprises the steps of first receiving a video portion and an associated audio portion of, for example, a television program; analyzing the audio portion to locate the presence of particular phonemes therein, and also analyzing the video portion to locate therein the presence of particular visemes therein. This is followed by analyzing the phonemes and the visemes to determine the relative timing of related phonemes and visemes thereof and locate muevs.

Another aspect of the invention is a method for measuring audio video synchronization by receiving video and associated audio information, analyzing the audio information to locate the presence of particular sounds and analyzing the video information to locate the presence of lip shapes corresponding to the formation of particular sounds, and comparing the location of particular sounds with the location of corresponding lip shapes of step to determine the relative timing of audio and video, e.g., muevs.

A further aspect of the invention is a method for measuring audio video synchronization, comprising the steps of receiving a video portion and an associated audio portion of a television program, and analyzing the audio portion to locate the presence of particular vowel sounds while analyzing the video portion to locate the presence of lip shapes corresponding to uttering particular vowel sounds, and analyzing the presence and/or location of vowel sounds located in step b) with the location of corresponding lip shapes of step c) to determine the relative timing thereof.

The invention provides methods, systems, and program products for identifying and locating muevs. As used herein the term “muev” is the contraction of MUtual EVent to mean an event occurring in an image, signal or data which is unique enough that it may be accompanied by another muev in an associated signal. Accordingly, an image muev may have a probability of matching a muev in an associated signal. For example in respect to the bat hitting the ball example above, the crack of the bat in the audio signal is a muev and the swing of the bat is also a muev. Clearly the two each have a probability of matching the other in time. The detection of the video muev may be accomplished by looking for motion, and in particular quick motion in one or a few limited area of the image while the rest of the image is static, i.e. the pitcher throwing the ball and the batter swinging at the ball. In the audio, the crack of the bat may be detected by looking for short, percussive sounds which are isolated in time from other short percussive sounds. One of ordinary skill in the art will recognize from these teachings that other muevs may be identified in associated signals and utilized for the present invention.

### THE FIGURES

Various embodiments and exemplifications of our invention are illustrated in the Figures.

FIG. 1 is an overview of a system for carrying out the method of the invention.

FIG. 2 shows a diagram of the present invention with images conveyed by a video signal and associated information conveyed by an associated signal and a synchronization output.

FIG. 3 shows a diagram of the present invention as used with a video signal conveying images and an audio signal conveying associated information.

FIG. 4 is a flow chart illustrating the “Data Acquisition Phase”, also referred to as an “A/V MuEv Acquisition and Calibration Phase” of the method of the invention.

FIG. 5 is a flow chart illustrating the “Audio Analysis Phase” of the method of the invention.

FIG. 6 is a flow chart illustrating the Video Analysis of the method of the invention.

FIG. 7 is a flow chart illustrating the derivation and calculation of the Audio MuEv, also referred to as a Glottal Pulse.

FIG. 8 is a flow chart illustrating the Test Phase of the method of the invention.

FIG. 9 is a flow chart illustrating the characteristics of the Audio MuEv also referred to as a Glottal Pulse.

### DETAILED DESCRIPTION

The preferred embodiment of the invention has an image input, an image mutual event identifier which provides image muevs, and an associated information input, an associated information mutual event identifier which provides associated information muevs. The image muevs and associated information muevs are suitably coupled to a comparison operation which compares the two types of muevs to determine their relative timing. In particular embodiments of the invention, muevs may be labeled in regard to the method of conveying images or associated information, or may be labeled in regard to the nature of the images or associated information. For example video muev, brightness muev, red muev, chroma muev and luma muev are some types of image muevs and audio muev, data muev, weight muev, speed muev and temperature muev are some types of associated muevs which may be commonly utilized.

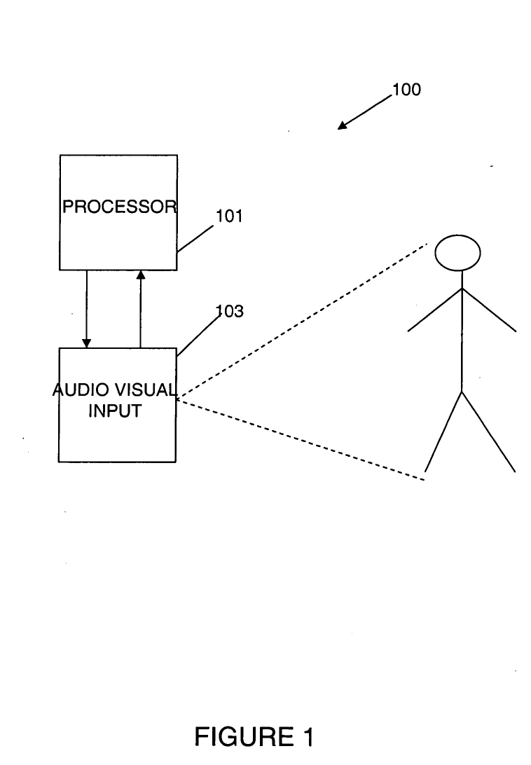

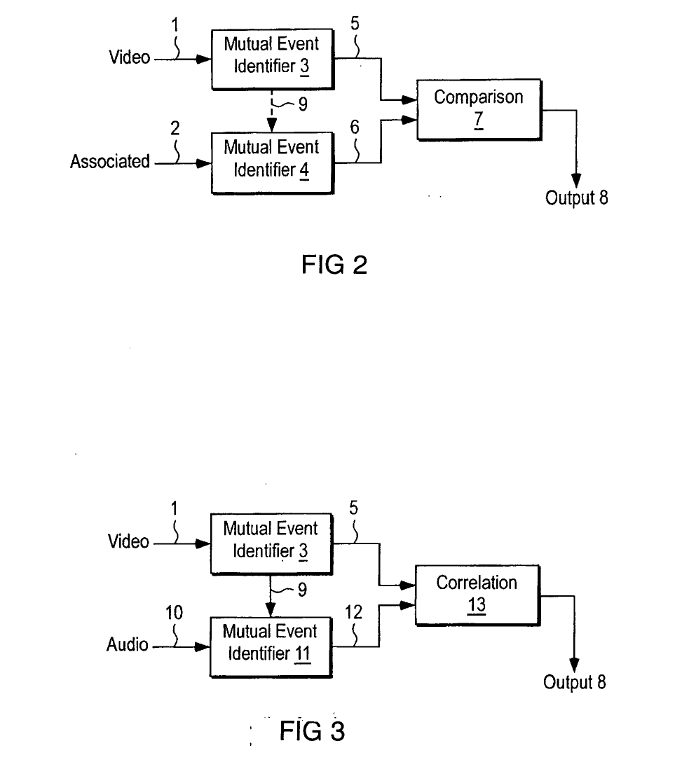

FIG. 1 shows the preferred embodiment of the invention wherein video conveys the images and an associated signal conveying the associated information. FIG. 1 has video input 1, mutual event identifier 3 with muev output 5, associated signal input 2, mutual event identifier 4 with muev output 6, comparison 7 with output 8.

In operation video signal 1 is coupled to an image muev identifier 3 which operates to compare a plurality of image frames of video to identify the movement (if present) of elements within the image conveyed by the video signal. The computation of motion vectors, commonly utilized with video compression such as in MPEG compression, is useful for this function. It is useful to discard motion vectors which indicate only small amounts of motion and use only motion vectors indicating significant motion in the order of 5% of the picture height or more. When such movement is detected, it is inspected relation to the rest of the video signal movement to determine if it is an event which is likely to have a corresponding muev in the associated signal.

A muev output is generated at 5 indicating the presence of the muev(s) within the video field or frame(s), in this example where there is movement that is likely to have a corresponding muev in the associated signal. In the preferred form it is desired that a binary number be output for each frame with the number indicating the number of muevs, i.e. small region elements which moved in that frame relative to the previous frame, while the remaining portion of the frame remained relatively static.

It may be noted that while video is indicated as the preferred method of conveying images to the image muev identifier 3, other types of image conveyances such as files, clips, data, etc. may be utilized as the operation of the present invention is not restricted to the particular manner in which the images are conveyed. Other types of image muevs may be utilized as well in order to optimize the invention for particular video signals or particular types of expected images conveyed by the video signal. For example the use of brightness changes within particular regions, changes in the video signal envelope, changes in the frequency or energy content of the video signal carrying the images and other changes in properties of the video signal may be utilized as well, either alone or in combination, to generate muevs.

The associated signal 2 is coupled to a mutual event identifier 4 which is configured to identify the occurrence of associated signal muevs within the associated signal. When muevs are identified as occurring in the associated signal a muev output is provided at 6. The muev output is preferred to be a binary number indicating the number of muevs which have occurred within a contiguous segment of the associates signal 2, and in particular within a segment corresponding in length to the field or frame period of the video signal 1 which is utilized for outputting the movement signal number 5. This time period may be coupled from movement identifier 3 to muev identifier 4 via suitable coupling 9 as will be known to persons of ordinary skill in the art from the description herein. Alternatively, video 1 may be coupled directly to muev identifier 4 for this and other purposes as will be known from these present teachings.

It may be noted that while a signal is indicated as the preferred method of conveying the associated information to the associated information muev identifier 4, other types of associated information conveyances such as files, clips, data, etc. may be utilized as the operation of the present invention is not restricted to the particular manner in which the associated information is conveyed. In the preferred embodiment of FIG. 1 the associated information is also known as the associated signal, owing to the preferred use of a signal for conveyance. Similarly, the associated information muevs are also known as associated signal muevs. The detection of muevs in the associated signal will depend in large part on the nature of the associated signal. For example data which is provided by or in response to a device which is likely present in the image such as data coming from the customer input to a teller machine would be a good muev. Audio characteristics which are likely correlated with motion are good muevs as discussed below. As other examples, the use of changes within particular regions of the associated signal, changes in the signal envelope, changes in the information, frequency or energy content of the signal and other changes in properties of the signal may be utilized as well, either alone or in combination, to generate muevs. More details of identification of muevs in particular signal types will be provided below in respect to the detailed embodiments of the invention.

Consequently, at every image, conveyed as a video field or frame period, a muev output is presented at 5 and a muev output is presented at 6. The image muev output, also known in this preferred embodiment as a video muev owing to the use of video as the method of conveying images, and the associated signal muev output are suitable coupled to comparison 7 which operates to determine the best match, on a sliding time scale, of the two outputs. In the preferred embodiment the comparison is preferred to be a correlation which determines the best match between the two signals and the relative time therebetween.

We implement AVSync (Audio Video Sync detection) based on the recognition of Muevs such as vowel sounds, silence, and consonant sounds, including, preferably, at least three vowel sounds and silence. Exemplary of the vowel sounds are the three vowel sounds, /AA/, /EE/ and /OO/. The algorithm described herein assumes speaker independence in its final implementation.

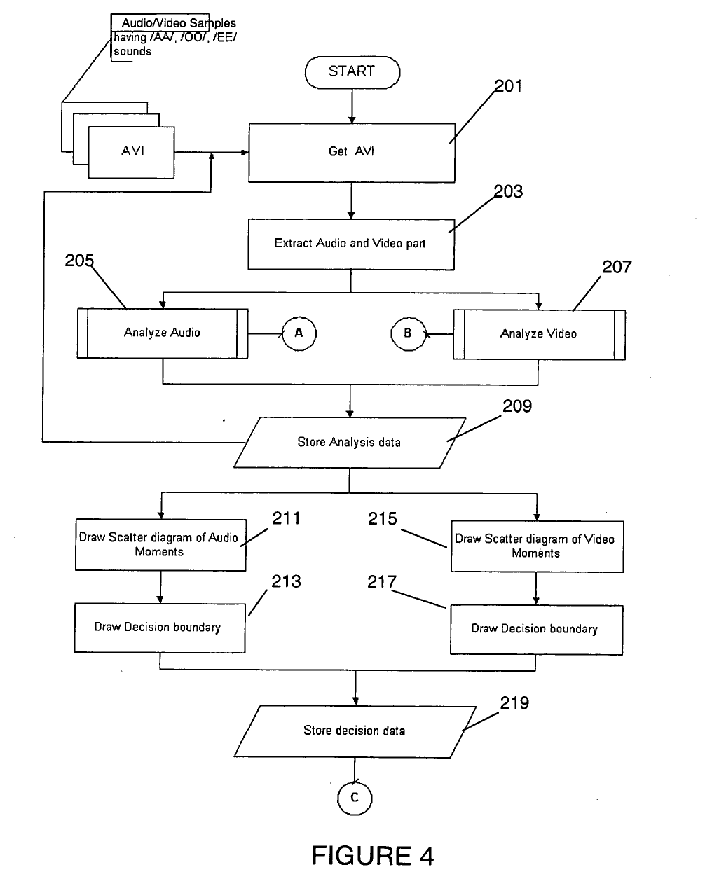

The first phase is an initial data acquisition phase, also referred to as an Audio/Video MuEv Acquisition and Calibration Phase shown generally in FIG. 4. In the initial data acquisition phase, experimental data is used to create decision boundaries and establish segmented audio regions for phonemes, that is, Audio MuEv's, /AA/, /OO/, /EE/. The methodology is not limited to only three vowels, but it can be expanded to include other vowels, or syllables, such as “lip-biting” “V” and “F”, etc.

At the same time corresponding visemes, that is, Video MuEvs, are created to establish distinctive video regions.

Those are used later, during the AVI analysis, positions of these vowels are identified in Audio and Video stream. Analyzing the vowel position in audio and the detected vowel in the corresponding video frame, audio-video synchronicity is estimated.

In addition to Audio-Video MuEv matching the silence breaks in both audio and video are detected and used to establish the degree of A/V synchronization.

During the AVI analysis, the positions of these vowels are identified in the Audio and Video stream. Audio-video synchronicity is estimated by analyzing the vowel position in audio and the detected vowel in the corresponding video frame.

In addition to phoneme-viseme matching the silence breaks in both audio and video may be detected and used to establish the degree of A/V synchronization.

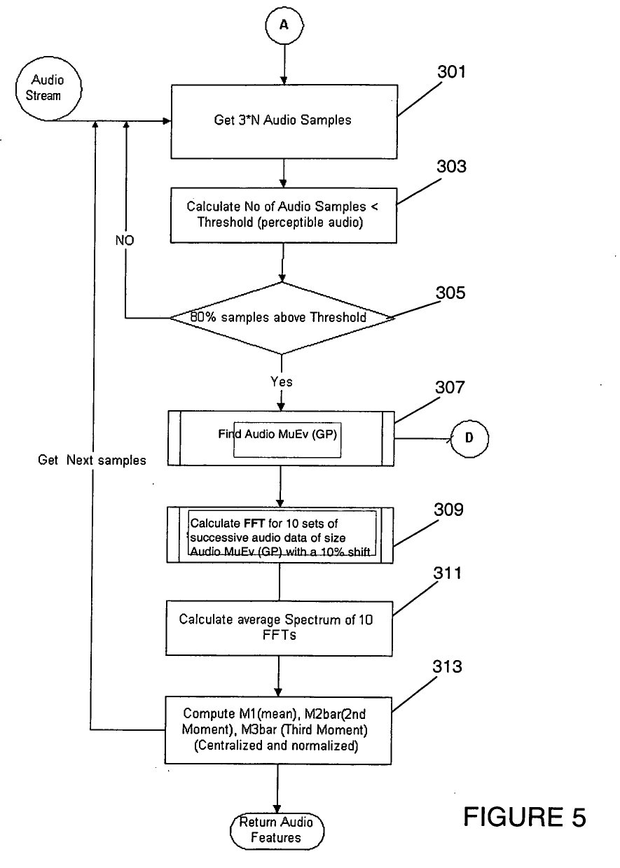

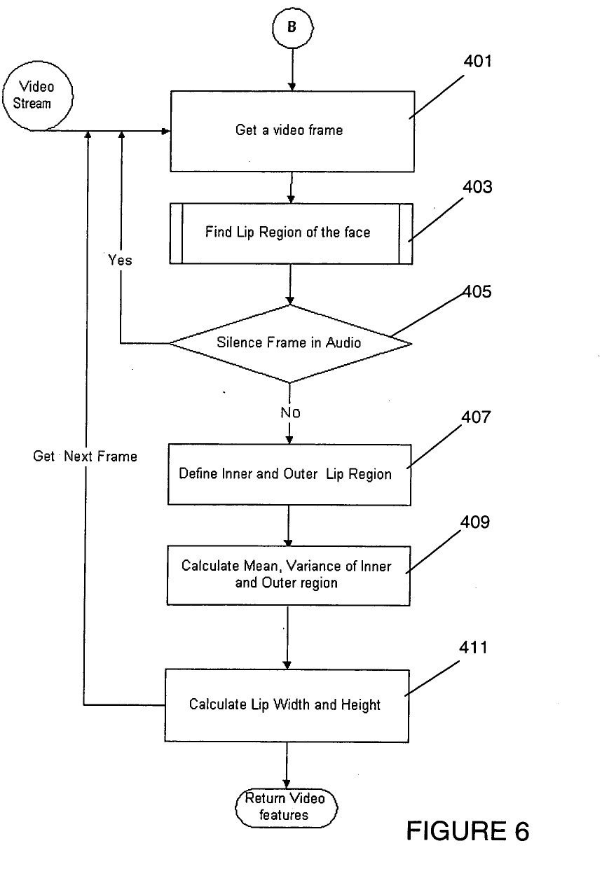

The next steps are Audio MuEv analysis and classification as shown in FIG. 5 and Video MuEv analysis and classification as shown in FIG. 6. Audio MuEv classification is based on Glottal Pulse analysis. In Glottal Pulse analysis shown and described in detail in FIG. 5, audio samples are collected and glottal pulses from audio samples in non-silence zones are calculated. For each glottal pulse period, the Mean, and the Second and Third Moments are computed. The moments are centralized and normalized around the mean. The moments were plotted as scattergram. Decision boundaries, which separated most of the vowel classes are drawn and stored as parameters for audio classification.

In the substantially parallel stage of Video Analysis and Classification, shown and described in greater detail in FIG. 6, the lip region for each video frame is extracted employing a face detector and lip tracker. The intensity values are preferably normalized to remove any lighting effects. The lip region is divided into sub-regions, typically two sub-regions—inner and outer. The inner region is formed by removing about 25% of the pixels from all four sides of the lip region. The difference of the lip-region and the inner region is considered as an outer region. Mean and standard deviation of all three regions are calculated. The mean/standard deviation of these regions is considered as video measure of spoken vowels, thus forming a corresponding Video MuEv

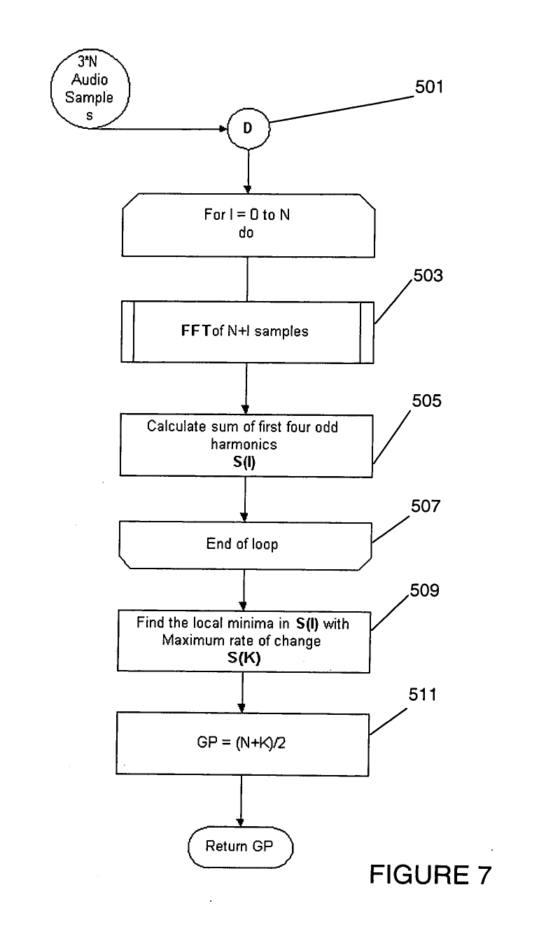

In the next phase, the detection phase, shown and described in greater detail in FIG. 7. One possible implementation of the detection phase, shown in FIG. 7, is to process the test data frame by frame. A large number of samples, e.g., about 450 audio samples or more, are taken as the audio window. For each audio window having more then some fraction, for example, 80%, non-silence data is processed to calculate an audio MuEv or GP (glottal pulse). The audio features are computed for Audio MuEv or GP samples. The average spectrum values over a plurality of audio frames, for example, over 10 or more consecutive audio frames with 10% shift, are used for this purpose. These are classified into vowel sounds such as /AA/, /OO/, /EE/, and into other vowel sounds, consonant sounds, and “F” and “V” sounds. For all those samples having more than two consecutive classes same, the corresponding video frame is checked. The video features for this frame are computed and classified as a corresponding video MuEv. The synchronicity is verified by analyzing these data.

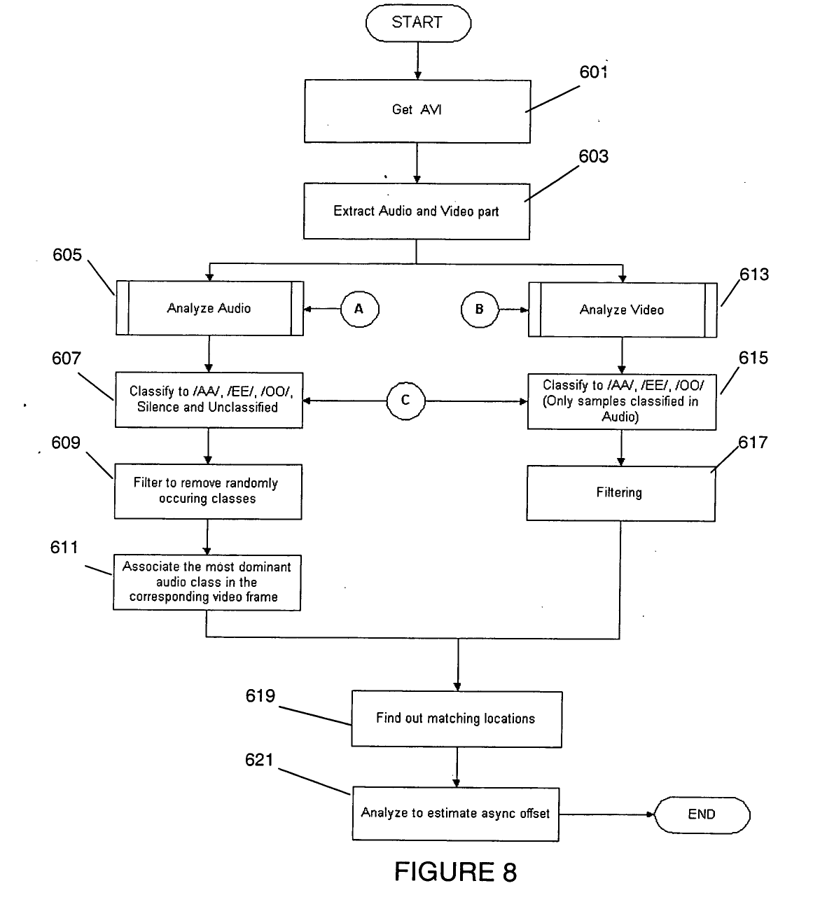

In the test phase, as shown and described in greater detail in FIG. 8, a dominant audio class in a video frame is determined and associated to a video frame to define a MUEV. This is accomplished by locating matching locations, and estimating offset of audio and video.

The step of acquiring data in an audio video synchronization system with input audio video information, that is, of Audio/Video MuEv Acquisition and Calibration, is as shown in FIG. 4. Data acquisition includes the steps of receiving audio video information 201, separately extracting the audio information and the video information 203, analyzing the audio information 205 and the video information 207, and recovering audio and video analysis data there from. The audio and video data is stored 209 and recycled.

Analyzing the data includes drawing scatter diagrams of audio moments from the audio data 211, drawing an audio decision boundary and storing the resulting audio decision data 213, drawing scatter diagrams of video moments from the video data 215. and drawing a video decision boundary 217 and storing the resulting video decision data 219

The audio information is analyzed, for example by a method such as is shown in FIG. 5. This method includes the steps of receiving an audio stream 301 until the fraction of captured audio samples reaches a threshold 303. If the fraction of captured audio reaches the threshold, the audio MuEv or glottal pulse of the captured audio samples is determined 307. The next step is calculating a Fast Fourier Transform for sets of successive audio data of the size of the audio MuEvs or glottal pulses within a shift 309. This is done by calculating an average spectrum of the Fast Fourier Transforms 311. and then calculating the audio statistics of the spectrum of the Fast Fourier Transforms of the glottal pulses 313; and returning the audio statistics. The detected audio statistics 313 include one or more of the centralized and normalized M1 (mean), M2BAR (2^{nd} Moment), M3BAR (3^{rd} Moment).

As shown in FIG. 7, calculating an audio MuEv or glottal pulse from the audio and video information to find an audio MuEv or glottal pulse of the captured audio samples by a method comprising the steps of receiving 3N audio samples 501, and for i=0 to N samples carrying out the steps of
i) determine the Fast Fourier Transform of N+1 audio samples 503;
ii) calculating a sum of the first four odd harmonics, S(I) 505;
iii) finding a local minima of S(I) with a maximum rate of change, S(K) 507; and
iv) calculating the audio MuEv or glottal pulse, GP=(N+K)/2 509.

The analysis of video information is as shown in FIG. 6 by a method that includes the steps of receiving a video stream and obtaining a video frame from the video frame 401, finding a lip region of a face in the video frame 403, and if the video frame is a silence frame, receiving a subsequent video frame 405. If the video frame is not a silence frame, the inner and outer lip regions of the face are defined 407, the mean and variance of the inner and outer lip regions of the face are calculated 409, and the width and height of the lips are calculated 411. The video features are returned and the next frame is received.

Determining and associating a dominant audio class in a video frame, locating matching locations, and estimating offset of audio and video by a method such as shown in FIG. 8. This method includes the steps of receiving a stream of audio and video information 601, retrieving individual audio and video information 603, analyzing the audio 605 and video information 613 and classifying the audio 607 and video information 615. This is followed by filtering the audio 609 and video information 617 to remove randomly occurring classes, and associating the most dominant audio classes to corresponding video frames 611, finding matching locations 619; and estimating an async offset. 621.

The audio and video information is classified into vowel sounds including at least AA, EE, OO, silence, and unclassified phonemes. This is without precluding other vowel sounds, and also consonant sounds.

A further aspect of our invention is a system for carrying out the above described method of measuring audio video synchronization. This is done by a method comprising the steps of Initial A/V MuEv Acquisition and Calibration Phase of an audio video synchronization system thus establishing a correlation of related Audio and Video MuEv-s, and Analysis phase which involves taking input audio video information, analyzing the audio information, analyzing the video information, calculating Audio MuEv and Video MuEv from the audio and video information; and determining and associating a dominant audio class in a video frame, locating matching locations, and estimating offset of audio and video.

A further aspect of our invention is a program product comprising computer readable code for measuring audio video synchronization. This is done by a method comprising the steps of Initial A/V MuEv Acquisition and Calibration Phase of an audio video synchronization system thus establishing a correlation of related Audio and Video MuEv-s, and Analysis phase which involves taking input audio video information, analyzing the audio information, analyzing the video information, calculating Audio MuEv and Video MuEv from the audio and video information; and determining and associating a dominant audio class in a video frame, locating matching locations, and estimating offset of audio and video.

The invention may be implemented, for example, by having the various means of receiving video signals and associated signals, identifying Audio-visual events and comparing video signal and associated signal Audio-visual events to determine relative timing as a software application (as an operating system element), a dedicated processor, or a dedicated processor with dedicated code. The software executes a sequence of machine-readable instructions, which can also be referred to as code. These instructions may reside in various types of signal-bearing media. In this respect, one aspect of the present invention concerns a program product, comprising a signal-bearing medium or signal-bearing media tangibly embodying a program of machine-readable instructions executable by a digital processing apparatus to perform a method for receiving video signals and associated signals, identifying Audio-visual events and comparing video signal and associated signal Audio-visual events to determine relative timing.

This signal-bearing medium may comprise, for example, memory in server. The memory in the server may be non-volatile storage, a data disc, or even memory on a vendor server for downloading to a processor for installation. Alternatively, the instructions may be embodied in a signal-bearing medium such as the optical data storage disc. Alternatively, the instructions may be stored on any of a variety of machine-readable data storage mediums or media, which may include, for example, a “hard drive”, a RAID array, a RAMAC, a magnetic data storage diskette (such as a floppy disk), magnetic tape, digital optical tape, RAM, ROM, EPROM, EEPROM, flash memory, magneto-optical storage, paper punch cards, or any other suitable signal-bearing media including transmission media such as digital and/or analog communications links, which may be electrical, optical, and/or wireless. As an example, the machine-readable instructions may comprise software object code, compiled from a language such as “C++”.

Additionally, the program code may, for example, be compressed, encrypted, or both, and may include executable files, script files and wizards for installation, as in Zip files and cab files. As used herein the term machine-readable instructions or code residing in or on signal-bearing media include all of the above means of delivery.

Audio MuEv (Glottal Pulse) Analysis. The method, system, and program product described is based on glottal pulse analysis. The concept of glottal pulse arises from the short comings of other voice analysis and conversion methods. Specifically, the majority of prior art voice conversion methods deal mostly with the spectral features of voice. However, a short coming of spectral analysis is that the voice's source characteristics cannot be entirely manipulated in the spectral domain. The voice's source characteristics affect the voice quality of speech defining if a voice will have a modal (normal), pressed, breathy, creaky, harsh or whispery quality. The quality of voice is affected by the shape length, thickness, mass and tension of the vocal folds, and by the volume and frequency of the pulse flow.

A complete voice conversion method needs to include a mapping of the source characteristics. The voice quality characteristics (as referred to glottal pulse) are much more obvious in the time domain than in the frequency domain. One method of obtaining the glottal pulse begins by deriving an estimate of the shape of the glottal pulse in the time domain. The estimate of the glottal pulse improves the source and the vocal tract deconvolution and the accuracy of formant estimation and mapping.

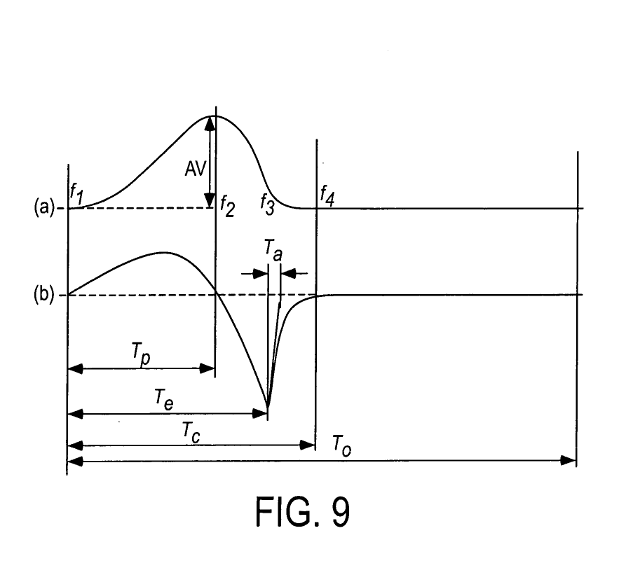

According to one method of glottal pulse analysis, a number of parameters, the laryngeal parameters are used to describe the glottal pulse. The parameters are based on the LF (Liljencrants/Fant) model illustrated in FIG. 9. According to LF model the glottal pulse has two main distinct time characteristics: the open quotient (OQ=T_{c}/T₀) is the fraction of each period the vocal folds remain open and the skew of the pulse or speed quotient (α=Tₚ/T_{c}) is the ratio of Tₚ, the duration of the opening phase of the open phase, to T_{c} the total duration of the open phase of the vocal folds. To complete the glottal flow description, the pitch period T₀, the rate of closure (RC=(T_{c}−Tₚ)/T_{c}) and the magnitude (AV) are included.

Estimation of the five parameters of LF model requires an estimation of the glottal closure instant (GCI). The estimation of the GCI exploits the fact that the average group delay value of the minimum phase signal is proportional to the shift between the start of the signal and the start of the analysis window. At the instant when the two coincide, the average group delay is of zero value. The analysis window length is set to a value that is just slightly higher that the corresponding pitch period. It is shifted in time by one sample across the signal and each time the unwrapped phase spectrum of the LPC residual is extracted. The average group delay value corresponding to the start of the analysis window is found by the slope of the linear regression fit. The subsequent filtering does not affect the temporal properties of the signal but eliminates possible fluctuations that could result in spurious zero crossing. The GCI is thus the zero crossing instant during the positive slope of average delay.

After estimation of the GCI, the LF model parameters are obtained from an iterative application of a dynamic time alignment method to an estimate of the glottal pulse sequence. The initial estimate of the glottal pulse is obtained via an LP inverse filter. The estimate of the parameters of LP model is based on a pitch synchronous method using periods of zero-excitation coinciding with the close phase of a glottal pulse cycle. The parameterization process can be divided into two stages:
(a) Initial estimation of the LF model parameters. An initial estimate of each parameter is obtained from analysis of an initial estimate of the excitation sequence. The parameter Tₑ corresponds to the instant when the glottal derivative signal reaches its local minimum. The parameter AVis the magnitude of the signal at this instant. The parameter Tₚ can be estimated as the first zero crossing to the left of T_{e.} The parameter T_{c} can be found as the first sample, to the right of Tₑ, smaller than a certain preset threshold value. Similarly, the parameter T₀ can be estimated as the instant to the left of Tₚ when the signal is lower than a certain threshold value and is constrained by the value of open quotient. It is particularly hard to obtain an accurate estimate of Tₐ so it is simply set to ⅔*(Tₑ−T_{c}). The apparent loss in accuracy due to this simplification is only temporary as after the non-linear optimization technique is applied, Ta is estimated as the magnitude of the normalized spectrum (normalized by AV) during the closing phase.
(b) Constrained non-linear optimization of the parameters. A dynamic time warping (DTW) method is employed. DTW time-aligns a synthetically generated glottal pulse with the one obtained through the inverse filtering. The aligned signal is a smoother version of the modeled signal, with its timing properties undistorted, but with no short term or other time fluctuations present in the synthetic signal. The technique is used iteratively, as the aligned signal can replace the estimated glottal pulse as the new template from which to estimate the LF parameters.

While the invention has been described in the preferred embodiment with various features and functions herein by way of example, the person of ordinary skill in the art will recognize that the invention may be utilized in various other embodiments and configurations and in particular may be adapted to provide desired operation with preferred inputs and outputs without departing from the spirit and scope of the invention.

We claim

1. A method for measuring audio video synchronization, said method comprising the steps of:
a) receiving a video portion and an associated audio portion of a television program;
b) analyzing the audio portion to locate the presence of particular phonemes therein;
c) analyzing the video portion to locate therein the presence of particular visemes therein; and
d) analyzing the phonemes in step b) and the visemes of step c) to determine the relative timing of related phonemes and visemes thereof.

2. A method for measuring audio video synchronization, said method comprising the steps of:
a) receiving video and associated audio information;
b) analyzing the audio information to locate the presence of particular sounds therein;
c) analyzing the video information to locate therein the presence of lip shapes corresponding to the formation of particular sounds, and
d) comparing the location of particular sounds located in step b) with the location of corresponding lip shapes of step c) to determine the relative timing thereof.

3. A method for measuring audio video synchronization, said method comprising the steps of:
a) receiving a video portion and an associated audio portion of a television program;
b) analyzing the audio portion to locate the presence of particular vowel sounds therein;
c) analyzing the video portion to locate therein the presence of lip shapes corresponding to uttering particular vowel sounds.
d) analyzing the presence and/or location of vowel sounds located in step b) with the location of corresponding lip shapes of step c) to determine the relative timing thereof.

4. A method of measuring audio video synchronization comprising the steps of:
a) acquiring input audio video information into an audio video synchronization system;
b) analyzing the audio information;
c) analyzing the video information;
d) calculating a an Audio MuEv and a Video MuEv from the audio and video information; and
e) determining and associating a dominant audio class in a video frame, locating matching locations, and estimating offset of audio and video.

5. The method of claim 4 wherein the step of acquiring input audio video information into an audio video synchronization system with input audio video information comprises the steps of:
a) receiving audio video information;
b) separately extracting the audio information and the video information;
c) analyzing the audio information and the video information, and recovering audio and video analysis data there from; and
d) storing the audio and video analysis data and recycling the audio and video analysis data.

6. The method of claim 5 comprising drawing scatter diagrams of audio moments from the audio data;

7. The method of claim 6 comprising drawing an audio decision boundary and storing the resulting audio decision data.

8. The method of claim 5 comprising drawing scatter diagrams of video moments from the video data;

9. The method of claim 8 comprising drawing a video decision boundary and storing the resulting video decision data.

10. The method of claim 7 comprising analyzing the audio information by a method comprising the steps of:
a) receiving an audio stream until the fraction of captured audio samples attains a threshold;
b) finding a glottal pulse of the captured audio samples;
c) calculating a Fast Fourier Transform for sets of successive audio data of the size of the glottal pulse within a shift;
d) calculating an average spectrum of the Fast Fourier Transforms;
e) calculating audio statistics of the spectrum of the Fast Fourier Transforms of the glottal pulses; and
f) returning the audio statistics.

11. The method of claim 10 wherein the audio statistics include one or more of the centralized and normalized M1 (mean), M2BAR (2^{nd} Moment), M3BAR (3^{rd} Moment).

12. The method of claim 10 comprising calculating a glottal pulse from the audio and video information to find a glottal pulse of the captured audio samples by a method comprising the steps of:
a) receiving 3N audio samples;
b) for i=0 to N samples
i) determine the Fast Fourier Transform of N+1 audio samples;
ii) calculating a sum of the first four odd harmonics, S(I);
iii) finding a local minima of S(I) with a maximum rate of change, S(K); and
iv) calculating the glottal pulse, GP=(N+K)/2.

13. The method of claim 4 comprising analyzing the video information by a method comprising the steps of:
a) receiving a video stream and obtaining a video frame there from;
b) finding a lip region of a face in the video frame;
c) if the video frame is a silence frame, receiving a subsequent video frame;
and
d) if the video frame is not a silence frame,
i) defining inner and outer lip regions of the face;
ii) calculating mean and variance of the inner and outer lip regions of the face;
iii) calculating the width and height of the lips; and
iv) returning video features and receiving the next frame.

14. The method of claim 4 comprising determining and associating a dominant audio class in a video frame, locating matching locations, and estimating offset of audio and video by a method comprising the steps of:
a) receiving a stream of audio and video information;
b) retrieving individual audio and video information there from;
c) analyzing the audio and video information and classifying the audio and video information;
d) filtering the audio and video information to remove randomly occurring classes;
e) associating most dominant audio classes to corresponding video frames; finding matching locations; and
f) estimating an async offset.

15. The method of claim 14 comprising classifying the audio and video information into vowel sounds including AA, EE, OO, silence, and unclassified phonemes.

16. A system for measuring audio video synchronization by a method comprising the steps of:
a) acquiring input audio video information into an audio video synchronization system;
b) analyzing the audio information;
c) analyzing the video information;
d) calculating an Audio MuEv and a Video MuEv from the audio and video information; and
e) determining and associating a dominant audio class in a video frame, locating matching locations, and estimating offset of audio and video.

17. The system of claim 16 wherein the step of acquiring input audio video information into an audio video synchronization system comprises the steps of:
a) receiving audio video information;
b) separately extracting the audio information and the video information;
c) analyzing the audio information and the video information, and recovering audio and video analysis data there from; and
d) storing the audio and video analysis data and recycling the audio and video analysis data.

18. The system of claim 17 wherein said system draws scatter diagrams of audio moments from the audio data.

19. The system of claim 18 wherein the system draws an audio decision boundary and storing the resulting audio decision data.

20. The system of claim 17 wherein the system draws scatter diagrams of video moments from the video data;

21. The system of claim 20 wherein the system draws a video decision boundary and storing the resulting video decision data.

22. The system of claim 19 wherein the system analyzes the audio information by a method comprising the steps of:
a) receiving an audio stream until the fraction of captured audio samples attains a threshold;
b) finding a glottal pulse of the captured audio samples;
c) calculating a Fast Fourier Transform for sets of successive audio data of the size of the glottal pulse within a shift;
d) calculating an average spectrum of the Fast Fourier Transforms;
e) calculating audio statistics of the spectrum of the Fast Fourier Transforms of the glottal pulses; and
f) returning the audio statistics.

23. The system of claim 22 wherein the audio statistics include one or more of the centralized and normalized M1 (mean), M2BAR (2^{nd} Moment), M3BAR (3^{rd} Moment).

24. The system of claim 22 wherein the system calculates a glottal pulse from the audio and video information to find a glottal pulse of the captured audio samples by a method comprising the steps of:
a) receiving 3N audio samples;
b) for i=0 to N samples
i) determine the Fast Fourier Transform of N+1 audio samples;
ii) calculating a sum of the first four odd harmonics, S(I);
iii) finding a local minima of S(I) with a maximum rate of change, S(K); and
iv) calculating the glottal pulse, GP=(N+K)/2.

25. The system of claim 19 wherein the system analyzes the video information by a method comprising the steps of:
a) receiving a video stream and obtaining a video frame there from;
b) finding a lip region of a face in the video frame;
c) if the video frame is a silence frame, receiving a subsequent video frame; and
d) if the video frame is not a silence frame,
i) defining inner and outer lip regions of the face;
ii) calculating mean and variance of the inner and outer lip regions of the face;
iii) calculating the width and height of the lips; and
iv) returning video features and receiving the next frame.

26. The system of claim 19 wherein the system determines and associates a dominant audio class in a video frame, locates matching locations, and estimates offset of audio and video by a method comprising the steps of:
a) receiving a stream of audio and video information;
b) retrieving individual audio and video information there from;
c) analyzing the audio and video information and classifying the audio and video information;
d) filtering the audio and video information to remove randomly occurring classes;
e) associating most dominant audio classes to corresponding video frames;
finding matching locations; and
f) estimating an async offset.

27. The system of claim 26 wherein the system classifies the audio and video information into vowel sounds including AA, EE, OO, silence, and unclassified phonemes.

28. A program product comprising computer readable code for measuring audio video synchronization by a method comprising the steps of:
a) receiving video and associated audio information;
b) analyzing the audio information to locate the presence of glottal events therein;
c) analyzing the video information to locate the presence of lip shapes corresponding to audio glottal events therein; and
d) analyzing the location and/or presence of glottal events located in step b) and corresponding video information of step c) to determine the relative timing thereof.

29. A program product comprising computer readable code for measuring audio video synchronization by a method comprising the steps of:
a) acquiring audio video input information into an audio video synchronization system;
b) analyzing the audio information;
c) analyzing the video information;
d) calculating an Audio MuEv and a Video MuEv from the audio and video information; and
e) determining and associating a dominant audio class in a video frame, locating matching locations, and estimating offset of audio and video.

30. The program product of claim 29 wherein the step of acquiring audio video input information into the audio video synchronization system comprises the steps of:
a) receiving audio video information;
b) separately extracting the audio information and the video information;
c) analyzing the audio information and the video information, and recovering audio and video analysis data there from; and
d) storing the audio and video analysis data and recycling the audio and video analysis data.

31. The program product of claim 30 wherein step of acquiring audio video input information into an audio video synchronization system further comprises the step of drawing scatter diagrams of audio moments from the audio data;

32. The program product of claim 31 wherein the step of acquiring audio video information in an audio video synchronization system further comprises drawing an audio decision boundary and storing the resulting audio decision data.

33. The program product of claim 30 wherein analyzing an audio and video stream in an audio and video synchronization system further comprises drawing scatter diagrams of video moments from the video data;

34. The program product of claim 33 wherein analyzing an audio and video stream in an audio and video synchronization system further comprises drawing a video decision boundary and storing the resulting video decision data.

35. The program product of claim 29 wherein analyzing an audio and video stream in an audio and video synchronization system further comprises analyzing the audio information by a program product comprising the steps of:
a) receiving an audio stream until the fraction of captured audio samples attains a threshold;
b) finding a glottal pulse of the captured audio samples;
c) calculating a Fast Fourier Transform for sets of successive audio data of the size of the glottal pulse within a shift;
d) calculating an average spectrum of the Fast Fourier Transforms;
e) calculating audio statistics of the spectrum of the Fast Fourier Transforms of the glottal pulses; and
f) returning the audio statistics.

36. The program product of claim 35 wherein the audio statistics include one or more of the centralized and normalized M1 (mean), M2BAR (2^{nd} Moment), M3BAR (3^{rd} Moment).

37 The program product of claim 35 wherein analyzing an audio and video stream in an audio and video synchronization system further comprises calculating a glottal pulse from the audio and video information to find a glottal pulse of the captured audio samples by a program product comprising the steps of:
a) receiving 3N audio samples;
b) for i=0 to N samples
i) determine the Fast Fourier Transform of N+1 audio samples;
ii) calculating a sum of the first four odd harmonics, S(I);
iii) finding a local minima of S(I) with a maximum rate of change, S(K); and
iv) calculating the glottal pulse, GP=(N+K)/2.

38. The program product of claim 29 wherein analyzing an audio and video stream in an audio and video synchronization system further comprises analyzing the video information by a program product comprising the steps of:
a) receiving a video stream and obtaining a video frame there from;
b) finding a lip region of a face in the video frame;
c) if the video frame is a silence frame, receiving a subsequent video frame;
and
d) if the video frame is not a silence frame,
i) defining inner and outer lip regions of the face;
ii) calculating mean and variance of the inner and outer lip regions of the face;
iii) calculating the width and height of the lips; and
iv) returning video features and receiving the next frame.

39. The program product of claim 29 wherein analyzing an audio and video stream in an audio and video synchronization system further comprises determining and associating a dominant audio class in a video frame, locating matching locations, and estimating offset of audio and video by a program product comprising the steps of:
a) receiving a stream of audio and video information;
b) retrieving individual audio and video information there from;
c) analyzing the audio and video information and classifying the audio and video information;
d) filtering the audio and video information to remove randomly occurring classes;
e) associating most dominant audio classes to corresponding video frames; finding matching locations; and
f) estimating an async offset.

40. The program product of claim 39 wherein analyzing an audio and video stream in an audio and video synchronization system further comprises classifying the audio and video information into vowel sounds including AA, EE, OO, silence, and unclassified phonemes.
